(19) United States
(12) Patent Application Publication
(10) Pub. No.: US 2024/0103858 A1
(43) Pub. Date: Mar. 28, 2024

(54) Instruction Support for Matrix Multiplication

(71) Applicant: Apple Inc., Cupertino, CA (US)

(72) Inventors: Ali Sazegari, Los Altos, CA (US); Matthew L. Badin, Santa Clara, CA (US)

(21) Appl. No.: 18/045,928

(22) Filed: Oct. 12, 2022

Related U.S. Application Data
(60) Provisional application No. 63/376,676, filed on Sep. 22, 2022.

(51) Int. Cl. G06F 9/30; G06F 17/16

(52) U.S. Cl. CPC G06F 9/3001; G06F 9/3013; G06F 17/16

(57) ABSTRACT

Techniques are disclosed relating to instruction set architecture support for matrix manipulations. In disclosed embodiments, front-end circuitry is configured to fetch and decode a matrix multiply instruction for execution, including to encode a given matrix input operand of the matrix multiply instruction to identify one or more vector registers defined according to an instruction set architecture. In some embodiments, datapath circuitry is configured to execute the matrix multiply instruction, where during execution of the instruction, the one or more vector registers corresponding to the given matrix operand are mapped within the datapath circuitry to at least two dimensions of the given matrix operand. In some embodiments, power management circuitry is configured to, during execution of the instruction, operate at least a portion of the front-end circuitry in a reduced-power mode. Disclosed techniques may advantageously increase throughput and reduce power consumption, relative to traditional implementations using vector operations.

This application claims priority to U.S. Prov. Appl. No. 63/376,676, filed Sep. 22, 2022, which is hereby incorporated by reference in its entirety.

### BACKGROUND

### Technical Field

This disclosure relates generally to computer processors and more particularly to instruction set architecture support for matrix manipulations.

### Description of the Related Art

Certain instruction set architectures (ISAs) include instructions that are configured to perform vector operations, but do not natively support matrix manipulations (e.g., a matrix multiplication operation). Accordingly, under such ISAs, a matrix operation may be performed by decomposing the matrix operation into a series of vector operations.

### BRIEF DESCRIPTION OF THE DRAWINGS

FIG. 1 is a block diagram illustrating example processor circuitry, according to some embodiments.

FIG. 2 is a diagram illustrating an example matrix multiplication operation with matrix dimensions mapped to vector register parameters, according to some embodiments.

FIG. 3A is a diagram illustrating example configuration information, according to some embodiments.

FIG. 3B is a diagram illustrating example fields for a matrix multiplication instruction, according to some embodiments.

FIG. 3C is a diagram illustrating example fields for a strided load instruction, according to some embodiments.

FIG. 4 is a block diagram illustrating example pipeline circuitry configured to execute a matrix multiplication instruction, according to some embodiments.

FIG. 5 is a flow diagram illustrating an example method, according to some embodiments.

FIG. 6 is a block diagram illustrating an example computing device, according to some embodiments.

FIG. 7 is a diagram illustrating example applications of disclosed systems and devices, according to some embodiments.

FIG. 8 is a block diagram illustrating an example computer-readable medium that stores circuit design information, according to some embodiments.

### DETAILED DESCRIPTION

As briefly discussed above, matrix manipulations are not natively supported in certain ISAs, but some ISAs define vector registers and support vector operations, such as RISC-V vector extension (RVV), ARM scalable vector extension (SVE) or NEON, x86 advanced vector extensions (AVX), SPARC visual instruction set (VIS), various graphics processor ISAs with SIMD/SIMT operations, etc. Some ISAs may support vector length agnostic (VLA) programming techniques with configurable vector lengths. Rather, matrix manipulations such as matrix multiplication may be implemented using multiple vector operations. In contrast, the present disclosure describes single-instruction matrix multiplication techniques. These techniques may advantageously increase throughput, e.g., by issuing multiple matrix operations in successive cycles. Similarly, these techniques may reduce power consumption by allowing front-end circuitry to power down more often, relative to implementing matrix operations using vector operations.

In some embodiments, discussed in detail below, processor front-end circuitry is configured to fetch a matrix multiply instruction and decode the instruction for execution. The matrix multiply instruction defines a plurality of matrix input operands, where the matrices include at least two dimensions. A given matrix input operand may be encoded to identify a set of vector registers defined according to an ISA. In some embodiments, datapath circuitry is configured to execute the matrix multiply instruction by mapping the vector registers to at least two dimensions of the given matrix operand. As one example, a vector register length may be mapped to one dimension and a number of vector registers may be mapped to another dimension.

In some embodiments, power management circuitry is configured to operate at least a portion of front-end circuitry in a reduced-power mode, during execution of the instruction. This may advantageously reduce overall power consumption while datapath circuitry executes the matrix multiplication instruction.

### Overview of Matrix Multiplication Circuitry

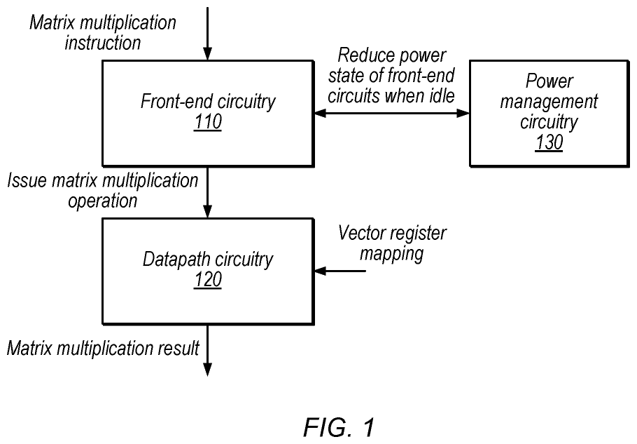

FIG. 1 is a block diagram illustrating example processor circuitry configured to perform matrix multiplication, according to some embodiments. The illustrated embodiment includes front-end circuitry 110, datapath circuitry 120, and power management circuitry 130.

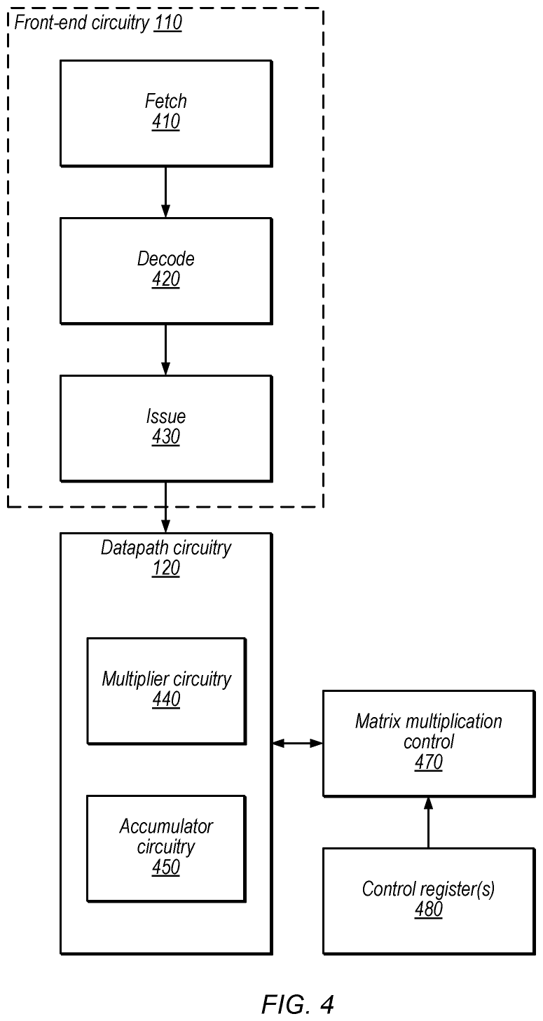

Front-end circuitry 110, in the illustrated embodiment, is configured to fetch and decode a matrix multiplication instruction for execution. Front-end circuitry 110 may include fetch, decode, and issue stages, as discussed below with reference to FIG. 4.

In some embodiments, the matrix multiplication instruction is defined to operate on a plurality of matrix input operands. In some embodiments, the matrices corresponding to the matrix input operands include at least two dimensions (e.g., rows and columns for a two-dimensional matrix). In some embodiments, a given matrix input operand of the matrix multiplication instruction is encoded to identify one or more vector registers, where the vector registers are defined according to an ISA (e.g., RISC-V). Note that architectural registers may be mapped to hardware registers differently in different implementations.

Power management circuitry 130, in the illustrated embodiment, is configured control the power state of one or more processing components, including front-end circuitry 110. In some situations, after fetching and decoding a matrix multiplication instruction, front-end circuitry 110 enters an idle state, e.g., where it is not fetching and decoding instructions. This may occur when in-flight instructions are stalled (e.g., because they are waiting for operands, depend on younger instructions, etc.) or no instructions currently need to be fetched. In such situations, power management circuitry 130 may clock gate, power gate, or otherwise reduce the power state of front-end circuitry 110 during a time interval in which datapath circuitry 120 executes the matrix multiplication instruction. This may reduce power consumption relative to performing a matrix multiplication using multiple vector-based instructions, which would keep front-end circuitry 110 busy for multiple fetch cycles.

Datapath circuitry 120, in the illustrated embodiment, is configured to execute various instructions including matrix multiplication instructions. Datapath circuitry 120 may control multiplication and accumulator circuitry to perform various operations as part of the matrix multiplication, to generate a matrix multiplication result, as discussed in detail below with reference to FIG. 4.

### Example Matrix Multiplication

In some embodiments, the encoding of matrix input operands maps a vector register length to one dimension and maps a number of vector registers in a register group to another dimension. Note that multiple vector registers may be grouped together (e.g., in RISC-V), so that a single vector instruction can operate on multiple vector registers. Thus a “vector register group” may be used as a single operand to a vector or matrix instruction. Vector register groups may allow larger elements to be operated on with the same vector length as single-width elements. A vector length multiplier, LMUL, when greater than 1, may represent the default number of vector registers that are combined to form a vector register group.

In some embodiments, the vector register length is a shared dimension between two input matrices. For example, a first matrix may have dimensions K×N and a second matrix may have dimensions N×M. In this case, the shared dimension is the N dimension of the first and second matrices. Disclosed mappings may advantageously allow existing ALU hardware and register control circuitry for vector operations to be re-used for a single ISA matrix multiplication instruction/operation.

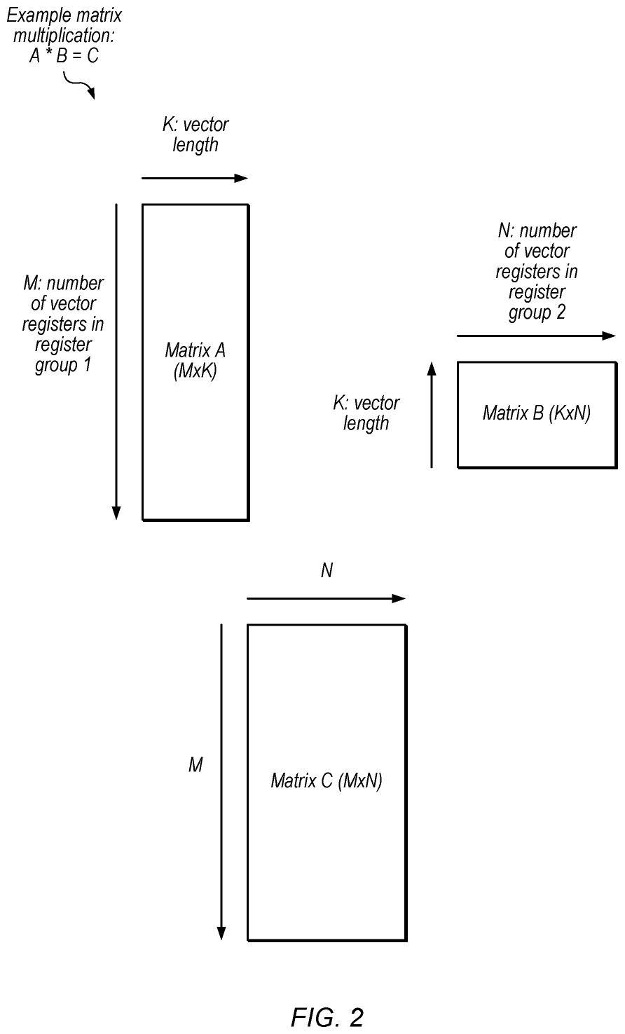

FIG. 2 is a diagram illustrating an example matrix multiplication operation based on such mappings, according to some embodiments. As shown, the matrix multiplication operation is mathematically described as A*B=C, where matrix A has dimensions M×K, matrix B has dimensions K×N, and matrix C has dimensions M×N. Note that dimensions are described in the following format: number-of-rows×number-of-columns.

In the illustrated example, matrix A's dimension M is configured as a number of vector registers in register group 1, while the dimension K is configured as a vector length. Similarly, matrix B's dimension K is configured as a vector length, while the dimension N is configured as a number of vector registers in register group 2.

As shown, the dimension K of matrices A and B is a common dimension (which may also be referred to as a shared dimension), a fundamental concept for matrix multiplication operations.

In the illustrated example, to perform a matrix multiplication operation, dot product operations are performed between the rows of matrix A and the columns of matrix B, to generate an output matrix C. This includes multiplying matching members of matrices A and B, and summing all multiplications between the matching members to generate the matrix C.

For example, if matrices A and B are both 2×2 matrices, then the matrix multiplication operation would be performed as follows: members in row 1 of matrix A are multiplied by respective members in column 1 of matrix B and summed to form a result in position (1, 1) of matrix C, members in row 1 of matrix A are multiplied by respective members in column 2 of matrix B and summed to form a result in position (1, 2) of matrix C, and so on.

The example above describes matrix multiplication for matrices of 2 dimensions, although the same or similar approaches may be taken for matrix multiplication for matrices of other dimensions.

### Example Fields and Configuration Information

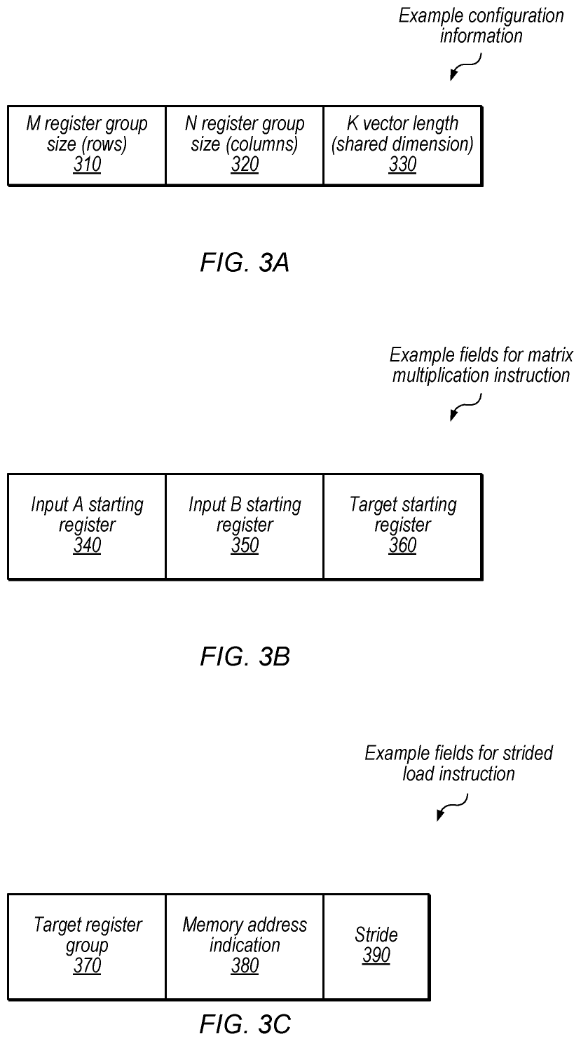

FIG. 3A is a block diagram illustrating example configuration information, according to some embodiments. The illustrated embodiment includes the following fields: M register group size (rows) 310, N register group size (columns) 320, and K vector length (shared dimension) 330. These fields may be used to setup the dimensions of the matrix multiplication operation, e.g., according to the notation of FIG. 2.

In some embodiments, configuration information 310-330 is stored in one or more configuration registers. In some embodiments, fields 310-330 are indicated by a separate configuration instruction (e.g., a “vsetm” instruction that is similar to the RISC-V vector extension operation vsetvli, but for matrix operations). In other embodiments, configuration information 310-330 is indicated in the matrix multiplication instruction, e.g., as immediate fields or via reference to a register or memory location.

FIG. 3B is a block diagram illustrating example fields for a matrix multiplication instruction, according to some embodiments. The illustrated embodiment includes input A starting register 340, input B starting register 350, and target starting register 360. These fields may indicate the starting vector registers for register groups of inputs A and B and the starting register for the register from of the result matrix. This information, in combination with the configuration information of FIG. 3A, may be sufficient for datapath circuitry 120 to perform the matrix multiplication.

FIG. 3C is a block diagram illustrating example field for a strided load instruction, according to some embodiments. The illustrated embodiment includes target register group 370, memory address indication 380, and stride value 390.

The target register group 370 indicates the register group to be loaded. The memory address indication (which may be stored in a general-purpose register) indicates the starting memory address from which to load, and the stride value 390 indicates the number of memory locations skipped between successive load locations. In some embodiments, an existing transpose load is used to load input matrices into their register groups while the strided load of FIG. 3C is used to load the target register group with the multiplication result. In some embodiments, a strided store instruction may be performed in a similar manner as described above with respect to a strided load instruction, with the exception that the strided store instruction is performed based on a source register group and a starting memory address to which to store. Generally, a strided memory access instruction may be a strided load or a strided store.

### Example Matrix Multiplication Pipeline Execution

FIG. 4 is a block diagram illustrating example pipeline circuitry configured to execute a matrix multiplication instruction, according to some embodiments. In the illustrated embodiment, a processor includes front-end circuitry 110, datapath circuitry 120, matrix multiplication control 470, and control register(s) 480. Front-end circuitry, in turn, includes fetch circuitry 410, decode circuitry 420, and issue circuitry 430. Datapath circuitry 120, in turn, includes multiplier circuitry 440 and accumulator circuitry 450.

Fetch stage 410, in the illustrated embodiment, is configured to fetch instructions (including matrix multiplication instructions defined to operate on multiple matrix input operands).

Decode stage 420, in the illustrated embodiment, is configured to decode instructions and may identify target execution circuitry based on the nature of decoded instructions. For matrix instructions, decode may include identifying vector registers mapped to input and output matrices. In some embodiments, the ISA is a RISC-V ISA that defines a set-vector-length instruction and the vector registers are vector length agnostic (VLA). In other embodiments, disclosed matrix multiplication techniques may be implemented in the context of other ISAs; RISC-V is discussed herein for purposes of explanation but is not intended to limit the scope of the present disclosure. As discussed above, decode stage 420 may also decode setup instructions that include fields such as those shown in FIG. 3A that program one or more control registers. Decode circuitry 420 may also identify segmented load and strided load instructions used to store input data in vector registers and store a result of a matrix multiply instruction, respectively.

Issue stage 430, in the illustrated embodiment, is configured to issue instructions to datapath circuitry 120 for execution. Issue stage 430 may utilize various known techniques to enforce dependencies before issuing instructions.

Datapath circuitry 120, in the illustrated embodiment, is configured to execute issued instructions. Datapath circuitry 120 may include multiple different types of execution units, e.g., for floating-point operations, integer operations, loads/stores, etc. As shown, datapath circuitry 120 includes multiplier circuitry 440 and accumulator circuitry 450 that may be used to perform portions of an overall matrix multiply operation.

Multiplier circuitry 440 is configured to perform one or more multiplication operations. In some embodiments, the number of multiplication operations performed by multiplier circuitry 440 is controlled by matrix multiplication control 470. Multiplier circuitry 440 may be implemented using various appropriate architectures, such as Wallace tree, array-style, etc.

Accumulator circuitry 450 is configured to accumulate one or more results of multiplication operations, e.g., to generate a result for an output matrix entry. In some embodiments, accumulator circuitry 450 performs one or more addition operations to sum the one or more multiplication operations performed by multiplier topologies 440. Accumulator circuitry 450 may be implemented using various appropriate architectures, such as Kogge-Stone, Ladner-Fischer, carry-save, carry-lookahead, etc.

Control register(s) 480, in the illustrated embodiment, are configured to store various parameters for matrix multiplication. For example, parameters may include the dimensions of the input matrices for the matrix multiplication instruction.

Matrix multiplication control 470, in the illustrated embodiment, is configured to control operations of datapath circuitry 120 based on parameters stored in control register(s) 480. For example, multiplication control 470 may specify the number of multiplication operations to perform (e.g., based on matrix dimensions), specific multiplication operations to be performed by multiplier circuitry 440, specific addition operations to be performed by accumulator circuitry 450, etc. Depending on the duplication of hardware elements in datapath circuitry 120, various operations for the matrix multiplication may be performed iteratively or in parallel.

### Example Method

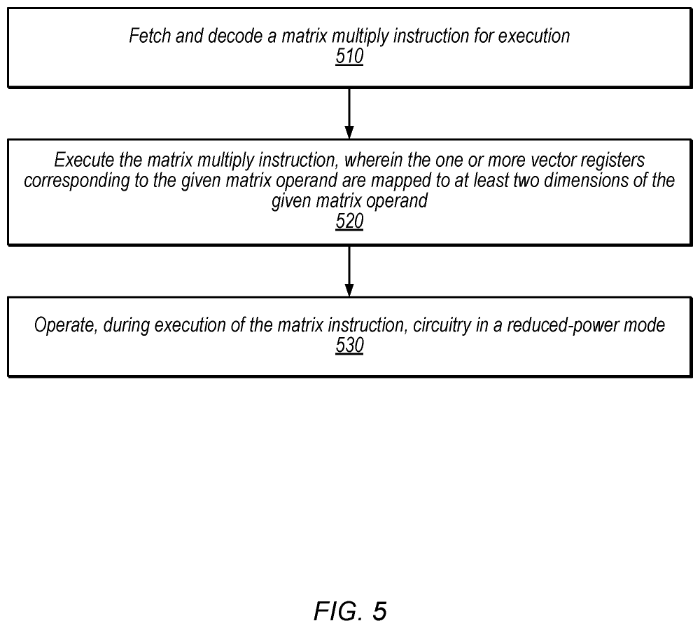

FIG. 5 is a flow diagram illustrating an example method for executing a matrix multiplication instruction for certain instruction set architectures, according to some embodiments. The method shown in FIG. 5 may be used in conjunction with any of the computer circuitry, systems, devices, elements, or components disclosed herein, among others. In various embodiments, some of the method elements shown may be performed concurrently, in a different order than shown, or may be omitted. Additional method elements may also be performed as desired.

At 510, in the illustrated embodiment, a computing device (e.g., front-end circuitry 110) fetches and decodes a matrix multiply instruction for execution.

In some embodiments, the matrix multiply instruction is defined to operate on a plurality of matrix input operands and to generate a matrix result, where matrices corresponding to the matrix input operands include at least two dimensions. In some embodiments, a given matrix input operand of the matrix multiply instruction is encoded to identify one or more vector registers defined according to an instruction set architecture (ISA).

In some embodiments, the computing device (e.g., front-end circuitry 110) fetches and decodes a segmented load instruction to store input data in vector registers for a given matrix input operand.

In some embodiments, the computing device (e.g., front-end circuitry 110) fetches and decodes a strided memory access instruction to store a result of the matrix multiply instruction, where the strided memory access instruction indicates a register group, a memory address, and a stride value. In some embodiments, the strided memory access instruction is a strided store instruction.

In some embodiments, the ISA is a RISC-V ISA that defines a set-vector-length and the vector registers are vector length agnostic (VLA).

At 520, in the illustrated embodiment, the computing device (e.g., datapath circuitry 120) executes the matrix multiply instruction, where the one or more vector registers corresponding to the given matrix operand are mapped to at least two dimensions of the given matrix operand.

In some embodiments, the mapping of the one or more vector registers to the at least two dimensions includes: a mapping of a vector register length to a first dimension and a mapping of a number of vector registers to a second dimension.

In some embodiments, the vector register length is a shared dimension between two input matrices that have different corresponding numbers of vector registers.

At 530, in the illustrated embodiment, a portion of the computing device (e.g., front-end circuitry 110) operates, during execution of the matrix multiply instruction, in a reduced-power mode.

In some embodiments, the computing device (e.g., front-end circuitry 110) is further configured to fetch and decode one or more setup instructions that program one or more control register with: a vector length and respective numbers of vector registers for two or more matrix input operands.

In some embodiments, the matrix multiply instruction includes at least the following fields: an indication of a target group of vector registers for the matrix result, an indication of a first source group of vector registers for a first matrix input operand, and an indication of a second source group of vector registers for a second matrix input operand.

### Example Device

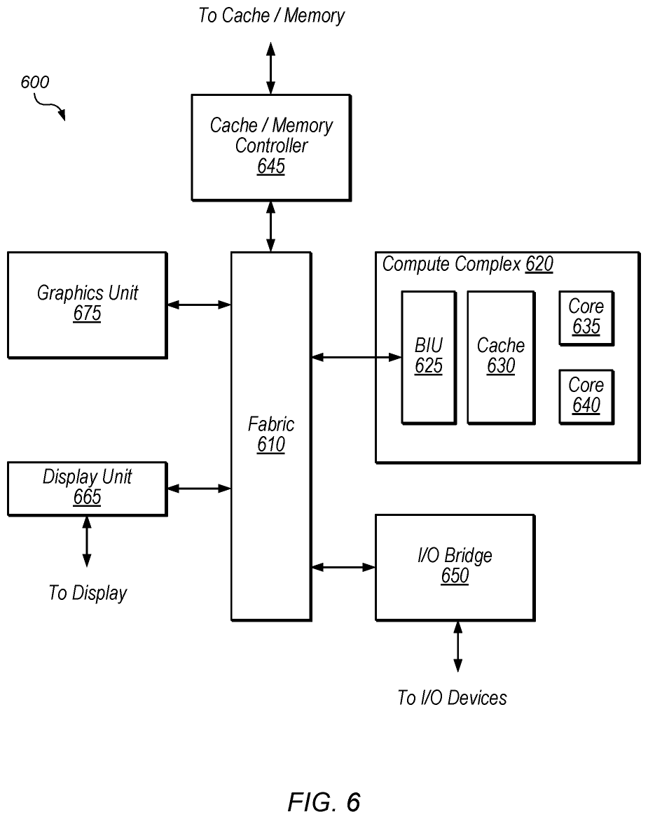

Referring now to FIG. 6, a block diagram illustrating an example embodiment of a device 600 is shown. In some embodiments, elements of device 600 may be included within a system on a chip. In some embodiments, device 600 may be included in a mobile device, which may be battery-powered. Therefore, power consumption by device 600 may be an important design consideration. In the illustrated embodiment, device 600 includes fabric 610, compute complex 620 input/output (I/O) bridge 650, cache/memory controller 645, graphics unit 675, and display unit 665. In some embodiments, device 600 may include other components (not shown) in addition to or in place of the illustrated components, such as video processor encoders and decoders, image processing or recognition elements, computer vision elements, etc.

Fabric 610 may include various interconnects, buses, MUX's, controllers, etc., and may be configured to facilitate communication between various elements of device 600. In some embodiments, portions of fabric 610 may be configured to implement various different communication protocols. In other embodiments, fabric 610 may implement a single communication protocol and elements coupled to fabric 610 may convert from the single communication protocol to other communication protocols internally.

In the illustrated embodiment, compute complex 620 includes bus interface unit (BIU) 625, cache 630, and cores 635 and 640. In various embodiments, compute complex 620 may include various numbers of processors, processor cores and caches. For example, compute complex 620 may include 1, 2, or 4 processor cores, or any other suitable number. In one embodiment, cache 630 is a set associative L2 cache. In some embodiments, cores 635 and 640 may include internal instruction and data caches. In some embodiments, a coherency unit (not shown) in fabric 610, cache 630, or elsewhere in device 600 may be configured to maintain coherency between various caches of device 600. BIU 625 may be configured to manage communication between compute complex 620 and other elements of device 600. Processor cores such as cores 635 and 640 may be configured to execute instructions of a particular instruction set architecture (ISA) which may include operating system instructions and user application instructions.

Cache/memory controller 645 may be configured to manage transfer of data between fabric 610 and one or more caches and memories. For example, cache/memory controller 645 may be coupled to an L3 cache, which may in turn be coupled to a system memory. In other embodiments, cache/memory controller 645 may be directly coupled to a memory. In some embodiments, cache/memory controller 645 may include one or more internal caches.

In some embodiments, compute complex 620 is configured to perform the matrix multiplication techniques discussed above.

As used herein, the term “coupled to” may indicate one or more connections between elements, and a coupling may include intervening elements. For example, in FIG. 6, graphics unit 675 may be described as “coupled to” a memory through fabric 610 and cache/memory controller 645. In contrast, in the illustrated embodiment of FIG. 6, graphics unit 675 is “directly coupled” to fabric 610 because there are no intervening elements.

Graphics unit 675 may include one or more processors, e.g., one or more graphics processing units (GPU's). Graphics unit 675 may receive graphics-oriented instructions, such as OPENGL®, Metal, or DIRECT3D® instructions, for example. Graphics unit 675 may execute specialized GPU instructions or perform other operations based on the received graphics-oriented instructions. Graphics unit 675 may generally be configured to process large blocks of data in parallel and may build images in a frame buffer for output to a display, which may be included in the device or may be a separate device. Graphics unit 675 may include transform, lighting, triangle, and rendering engines in one or more graphics processing pipelines. Graphics unit 675 may output pixel information for display images. Graphics unit 675, in various embodiments, may include programmable shader circuitry which may include highly parallel execution cores configured to execute graphics programs, which may include pixel tasks, vertex tasks, and compute tasks (which may or may not be graphics-related).

In some embodiments, graphics unit 675 is configured to perform the matrix multiplication techniques discussed above.

Display unit 665 may be configured to read data from a frame buffer and provide a stream of pixel values for display. Display unit 665 may be configured as a display pipeline in some embodiments. Additionally, display unit 665 may be configured to blend multiple frames to produce an output frame. Further, display unit 665 may include one or more interfaces (e.g., MIPI® or embedded display port (eDP)) for coupling to a user display (e.g., a touchscreen or an external display).

I/O bridge 650 may include various elements configured to implement: universal serial bus (USB) communications, security, audio, and low-power always-on functionality, for example. I/O bridge 650 may also include interfaces such as pulse-width modulation (PWM), general-purpose input/output (GPIO), serial peripheral interface (SPI), and inter-integrated circuit (I2C), for example. Various types of peripherals and devices may be coupled to device 600 via I/O bridge 650.

In some embodiments, device 600 includes network interface circuitry (not explicitly shown), which may be connected to fabric 610 or I/O bridge 650. The network interface circuitry may be configured to communicate via various networks, which may be wired, wireless, or both. For example, the network interface circuitry may be configured to communicate via a wired local area network, a wireless local area network (e.g., via WiFi), or a wide area network (e.g., the Internet or a virtual private network). In some embodiments, the network interface circuitry is configured to communicate via one or more cellular networks that use one or more radio access technologies. In some embodiments, the network interface circuitry is configured to communicate using device-to-device communications (e.g., Bluetooth or WiFi Direct), etc. In various embodiments, the network interface circuitry may provide device 600 with connectivity to various types of other devices and networks.

### Example Applications

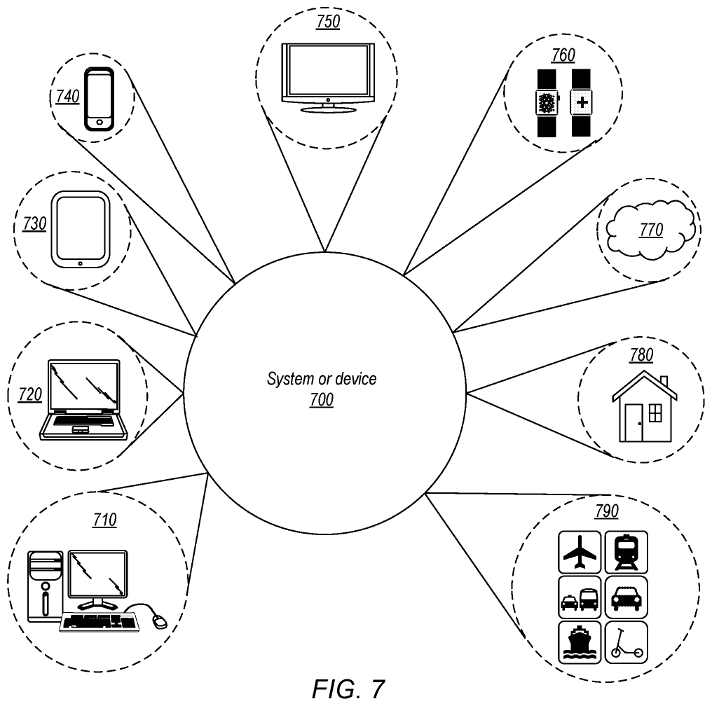

Turning now to FIG. 7, various types of systems that may include any of the circuits, devices, or system discussed above. System or device 700, which may incorporate or otherwise utilize one or more of the techniques described herein, may be utilized in a wide range of areas. For example, system or device 700 may be utilized as part of the hardware of systems such as a desktop computer 710, laptop computer 720, tablet computer 730, cellular or mobile phone 740, or television 750 (or set-top box coupled to a television).

Similarly, disclosed elements may be utilized in a wearable device 760, such as a smartwatch or a health-monitoring device. Smartwatches, in many embodiments, may implement a variety of different functions—for example, access to email, cellular service, calendar, health monitoring, etc. A wearable device may also be designed solely to perform health-monitoring functions, such as monitoring a user's vital signs, performing epidemiological functions such as contact tracing, providing communication to an emergency medical service, etc. Other types of devices are also contemplated, including devices worn on the neck, devices implantable in the human body, glasses or a helmet designed to provide computer-generated reality experiences such as those based on augmented and/or virtual reality, etc.

System or device 700 may also be used in various other contexts. For example, system or device 700 may be utilized in the context of a server computer system, such as a dedicated server or on shared hardware that implements a cloud-based service 770. Still further, system or device 700 may be implemented in a wide range of specialized everyday devices, including devices 780 commonly found in the home such as refrigerators, thermostats, security cameras, etc. The interconnection of such devices is often referred to as the “Internet of Things” (IoT). Elements may also be implemented in various modes of transportation. For example, system or device 700 could be employed in the control systems, guidance systems, entertainment systems, etc. of various types of vehicles 790.

The applications illustrated in FIG. 7 are merely exemplary and are not intended to limit the potential future applications of disclosed systems or devices. Other example applications include, without limitation: portable gaming devices, music players, data storage devices, unmanned aerial vehicles, etc.

### Example Computer-Readable Medium

The present disclosure has described various example circuits in detail above. It is intended that the present disclosure cover not only embodiments that include such circuitry, but also a computer-readable storage medium that includes design information that specifies such circuitry. Accordingly, the present disclosure is intended to support claims that cover not only an apparatus that includes the disclosed circuitry, but also a storage medium that specifies the circuitry in a format that is recognized by a fabrication system configured to produce hardware (e.g., an integrated circuit) that includes the disclosed circuitry. Claims to such a storage medium are intended to cover, for example, an entity that produces a circuit design, but does not itself fabricate the design.

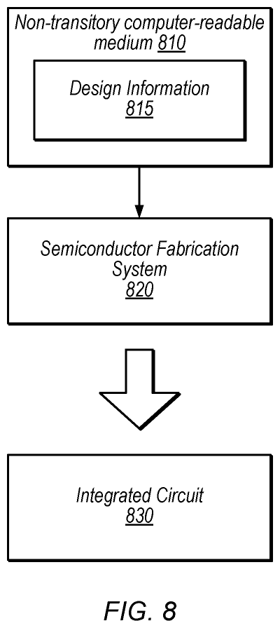

FIG. 8 is a block diagram illustrating an example non-transitory computer-readable storage medium that stores circuit design information, according to some embodiments. In the illustrated embodiment semiconductor fabrication system 820 is configured to process the design information 815 stored on non-transitory computer-readable medium 810 and fabricate integrated circuit 830 based on the design information 815.

Non-transitory computer-readable storage medium 810, may comprise any of various appropriate types of memory devices or storage devices. Non-transitory computer-readable storage medium 810 may be an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. Non-transitory computer-readable storage medium 810 may include other types of non-transitory memory as well or combinations thereof. Non-transitory computer-readable storage medium 810 may include two or more memory mediums which may reside in different locations, e.g., in different computer systems that are connected over a network.

Design information 815 may be specified using any of various appropriate computer languages, including hardware description languages such as, without limitation: VHDL, Verilog, SystemC, SystemVerilog, RHDL, M, MyHDL, etc. Design information 815 may be usable by semiconductor fabrication system 820 to fabricate at least a portion of integrated circuit 830. The format of design information 815 may be recognized by at least one semiconductor fabrication system 820. In some embodiments, design information 815 may also include one or more cell libraries which specify the synthesis, layout, or both of integrated circuit 830. In some embodiments, the design information is specified in whole or in part in the form of a netlist that specifies cell library elements and their connectivity. Design information 815, taken alone, may or may not include sufficient information for fabrication of a corresponding integrated circuit. For example, design information 815 may specify the circuit elements to be fabricated but not their physical layout. In this case, design information 815 may need to be combined with layout information to actually fabricate the specified circuitry.

Integrated circuit 830 may, in various embodiments, include one or more custom macrocells, such as memories, analog or mixed-signal circuits, and the like. In such cases, design information 815 may include information related to included macrocells. Such information may include, without limitation, schematics capture database, mask design data, behavioral models, and device or transistor level netlists. As used herein, mask design data may be formatted according to graphic data system (GDSII), or any other suitable format.

Semiconductor fabrication system 820 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 820 may also be configured to perform various testing of fabricated circuits for correct operation.

In various embodiments, integrated circuit 830 is configured to operate according to a circuit design specified by design information 815, which may include performing any of the functionality described herein. For example, integrated circuit 830 may include any of various elements shown in FIGS. 1 and 4. Further, integrated circuit 830 may be configured to perform various functions described herein in conjunction with other components. Further, the functionality described herein may be performed by multiple connected integrated circuits.

As used herein, a phrase of the form “design information that specifies a design of a circuit configured to . . . ” does not imply that the circuit in question must be fabricated in order for the element to be met. Rather, this phrase indicates that the design information describes a circuit that, upon being fabricated, will be configured to perform the indicated actions or will include the specified components.

The present disclosure includes references to “an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement and such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g. passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

1. An apparatus, comprising:
processor front-end circuitry configured to fetch a matrix multiply instruction and to decode the matrix multiply instruction for execution, wherein:
the matrix multiply instruction is defined to operate on a plurality of matrix input operands and to generate a matrix result;
matrices corresponding to the matrix input operands include at least two dimensions; and
a given matrix input operand of the matrix multiply instruction is encoded to identify one or more vector registers defined according to an instruction set architecture (ISA); and
datapath circuitry configured to execute the matrix multiply instruction, wherein during execution of the matrix multiply instruction, the one or more vector registers corresponding to the given matrix operand are mapped within the datapath circuitry to the at least two dimensions of the given matrix operand; and
power management circuitry configured to, during execution of the matrix multiply instruction within the datapath circuitry, operate at least a portion of the front-end circuitry in a reduced-power mode.

2. The apparatus of claim 1, wherein the mapping of the one or more vector registers to the at least two dimensions includes:
a mapping of a vector register length to a first dimension; and
a mapping of a number of vector registers to a second dimension.

3. The apparatus of claim 2, wherein the vector register length is a shared dimension between two input matrices that have different corresponding numbers of vector registers.

4. The apparatus of claim 2, wherein the front-end circuitry is further configured to fetch and decode one or more setup instructions that program one or more control registers with:
a vector length; and
respective numbers of vector registers for two or more matrix input operands.

5. The apparatus of claim 1, wherein the ISA is a RISC-V ISA that defines a set-vector-length instruction and the vector registers are vector length agnostic (VLA).

6. The apparatus of claim 1, wherein the front-end circuitry is further configured to fetch and decode a segmented load instruction to store input data in vector registers for a given matrix input operand.

7. The apparatus of claim 1, wherein the front-end circuitry is further configured to fetch and decode a strided memory access instruction, wherein the strided memory access instruction indicates:
a register group;
a memory address; and
a stride value.

8. The apparatus of claim 1, wherein the matrix multiply instruction includes at least the following fields:
an indication of a target group of vector registers for the matrix result;
an indication of a first source group of vector registers for a first matrix input operand; and
an indication of a second source group of vector registers for a second matrix input operand.

9. The apparatus of claim 1, wherein the apparatus is a computing device that further includes:
a display;
a processor that includes the front-end circuitry and the datapath circuitry; and
network interface circuitry.

10. The apparatus of claim 1, wherein the processor circuitry includes:
a plurality of single-instruction multiple-data pipelines configured to execute instructions; and
fixed-function circuitry configured to control the single-instruction multiple-data pipelines to perform operations for at least one of the following types of programs:
graphics shader programs; and
machine learning programs.

11. A method, comprising:
fetching and decoding, by front-end circuitry of a computing system, a matrix multiply instruction for execution wherein:
the matrix multiply instruction is defined to operate on a plurality of matrix input operands and to generate a matrix result;
matrices corresponding to the matrix input operands include at least two dimensions; and
a given matrix input operand of the matrix multiply instruction is encoded to identify one or more vector registers defined according to an instruction set architecture (ISA);
executing, by datapath circuitry of the computing system, the matrix multiply instruction, wherein during execution of the matrix multiply instruction, the one or more vector registers corresponding to the given matrix operand are mapped to at least two dimensions of the given matrix operand; and
operating, by power management circuitry of the computing system during execution of the matrix multiply instruction, at least a portion of the front-end circuitry in a reduced-power mode.

12. The method of claim 11, wherein the mapping of the one or more vector registers to the at least two dimensions includes:
a mapping of a vector register length to a first dimension; and
a mapping of a number of vector registers to a second dimension.

13. The method of claim 12, wherein the vector register length is a shared dimension between two input matrices that have different corresponding numbers of vector registers.

14. The method of claim 12, further comprising:
fetching, by the computing system, one or more setup instructions that program one or more control registers with a vector length and respective numbers of vector registers for two or more matrix input operands; and
decoding, by the computing system, the one or more setup instructions.

15. The method of claim 11, further comprising:
fetching, by the computing system, a strided memory access instruction to store a result of the matrix multiply instruction; and
decoding, by the computing system, the strided memory access instruction;
wherein the strided memory access instruction indicates:
a register group;
a memory address; and
a stride value.

16. A non-transitory computer readable storage medium having stored thereon design information that specifies a design of at least a portion of a hardware integrated circuit in a format recognized by a semiconductor fabrication system that is configured to use the design information to produce the circuit according to the design, wherein the design information specifies that the circuit includes:
processor front-end circuitry configured to fetch a matrix multiply instruction and to decode the matrix multiply instruction for execution, wherein:
the matrix multiply instruction is defined to operate on a plurality of matrix input operands and to generate a matrix result;
matrices corresponding to the matrix input operands include at least two dimensions; and
a given matrix input operand of the matrix multiply instruction is encoded to identify one or more vector registers defined according to an instruction set architecture (ISA); and
datapath circuitry configured to execute the matrix multiply instruction, wherein during execution of the matrix multiply instruction, the one or more vector registers corresponding to the given matrix operand are mapped within the datapath circuitry to the at least two dimensions of the given matrix operand; and
power management circuitry configured to, during execution of the matrix multiply instruction within the datapath circuitry, operate at least a portion of the front-end circuitry in a reduced-power mode.

17. The non-transitory computer readable storage medium of claim 16, wherein the mapping of the one or more vector registers to the at least two dimensions includes:
a mapping of a vector register length to a first dimension; and
a mapping of a number of vector registers to a second dimension.

18. The non-transitory computer readable storage medium of claim 17, wherein the vector register length is a shared dimension between two input matrices that have different corresponding numbers of vector registers.

19. The non-transitory computer readable storage medium of claim 17, wherein the front-end circuitry is further configured to fetch and decode one or more setup instructions that program one or more control registers with:
a vector length; and
respective numbers of vector registers for two or more matrix input operands.

20. The non-transitory computer readable storage medium of claim 16, wherein the matrix multiply instruction includes at least the following fields:
an indication of a target group of vector registers for the matrix result;
an indication of a first source group of vector registers for a first matrix input operand; and
an indication of a second source group of vector registers for a second matrix input operand.
